(19) United States
(12) Patent Application Publication
(10) Pub. No.: US 2007/0013469 A1
(43) Pub. Date: Jan. 18, 2007

(54) Ignition coil for an internal combustion engine

(76) Inventors: Konstantin Lindenthal, Blaichach (DE); Nikolaus Hautmann, Weitnau (DE); Markus Knepper, Waltenhofen/Oberdorf (DE)

Correspondence Address: KENYON & KENYON LLP, ONE BROADWAY, NEW YORK, NY, 10004, US

(21) Appl. No.: 11/472,095

(22) Filed: Jun. 20, 2006

(30) Foreign Application Priority Data
Jun. 22, 2005 (DE) 102005028814.6

(51) Int. Cl. H01F 27/30; H01F 27/24

(52) U.S. Cl. 336/209; 336/196; 336/234

(57) ABSTRACT

An ignition coil for an internal combustion engine has a core, about which a secondary coil shell and a primary coil shell are concentrically positioned. The spaces between the core, the secondary coil shell, and the primary coil shell are filled in by an encapsulating material. The core is made up of lamellar, magnetic steel sheets. To compensate for stresses resulting from the different thermal expansion coefficients of the components, an elastic layer is situated between at least two of the magnetic steel sheets of the core.

### BACKGROUND INFORMATION

An ignition coil is known from European Patent No. EP 0 859 383. In the case of the known ignition coil, its centrally situated core made up of lamellar metal sheets is surrounded by a shrink tube. When the temperature changes, the elasticity of the shrink tube allows it to compensate for stresses produced by the different expansion coefficients of the core, coil shell, and encapsulating material surrounding the coil core and the coil shell. This allows stress cracks to be prevented, in particular in the encapsulating material and the coil shell surrounding the core, and therefore allows voltage spark-over to be prevented. In this context, it is disadvantageous that the flexibility of the shrink tube does allow it to compensate for stresses occurring in the radial direction of the ignition coil, but that the material of the shrink tube is of a constant volume, which means that appropriate structural measures must be taken in the longitudinal direction of the ignition coil for purposes of compensation. In addition, the enclosing of the core by the shrink tube denotes an additional manufacturing step that accordingly includes possible sources of error. In addition, for space reasons, it is often not desirable to use an additional shrink tube.

### SUMMARY OF THE INVENTION

The ignition coil of the present invention for an internal combustion engine possesses the advantage that it may compensate for stresses between the core and the coil shells without a shrink tube surrounding the core. According to the present invention, this is achieved by positioning at least one elastic layer acting as a damping layer, between the lamellar core elements made out of sheet metal.

### BRIEF DESCRIPTION OF THE DRAWINGS

FIG. 1 shows a longitudinal cross-section of an ignition coil according to the present invention.

FIG. 2 shows a cross-section in the region of the core of the ignition coil according to FIG. 1.

FIG. 3 shows a cross-section of a core that is modified in comparison with FIG. 2.

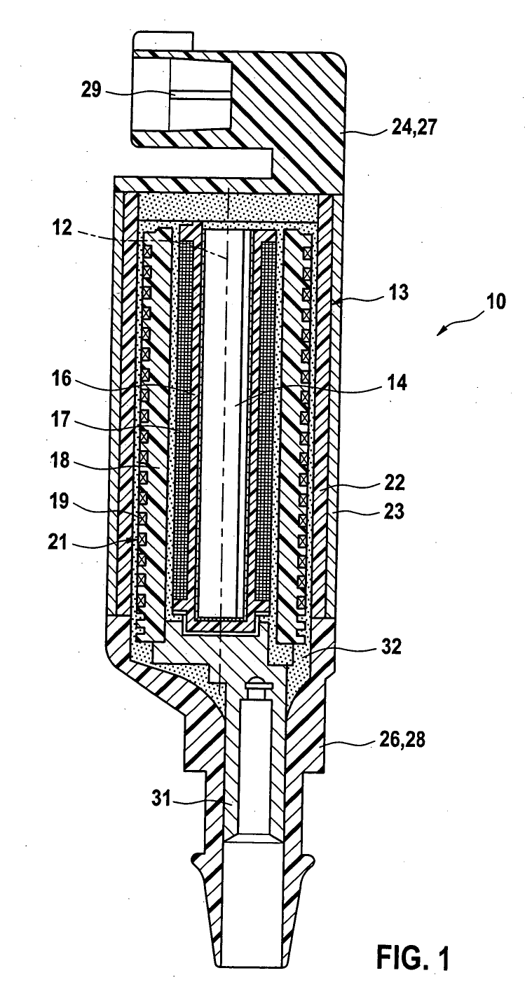

### DETAILED DESCRIPTION

An ignition coil 10 taking the form of a rod-type ignition coil for an internal combustion engine is designed to be directly contacted with a spark plug not shown, which is positioned in a shaft in the cylinder head of an internal combustion engine.

In a plastic housing 13, ignition coil 10 contains a cylindrical core 14, which is also referred to as an [-core and is situated coaxially with respect to a longitudinal axis 12, in a central position. The construction of core 14, which is part of an open magnetic circuit, will be discussed in further detail.

A secondary winding 17 carrying a high voltage is positioned concentrically about core 14, on a secondary coil shell 16. Positioned in turn on a radially adjacent, primary coil shell 18 is a primary winding 19 carrying a low voltage. The two windings 17, 19, together with coil shells 16, 18 made of electrically insulating plastic, form a winding set 21.

Primary winding 19 is surrounded by a central segment 22 of housing 13 at a short radial distance, the central segment of the housing having a longitudinal extension adapted to winding set 21.

Central segment 22 of housing 13 is in turn enveloped by a longitudinally slit, sleeve-shaped, sheet-metal yoke 23, which forms the outer sleeve of ignition coil 10 in this region of it. As a yoke element of the magnetic circuit of ignition coil 10, sheet-metal yoke 23 is used for conducting the magnetic field and is also referred to as an outer core.

Situated contiguously to central section 22 of housing 13 are, on one end, a first end segment 24 of housing 13 and, on the other end, a second end segment 26 of housing 13. First end segment 24 is embodied in a first terminal part 27, and second end segment 26 is embodied in a second terminal part 28.

First terminal part 27 has metallic attachment plugs 29, via which ignition coil 10 is powered by low voltage. Second terminal part 28 includes a metallic ferrule terminal (metallic connection sleeve) 31, via which the high voltage of ignition coil 10 is discharged to the spark plug.

The spaces in the interior of ignition coil 10 are filled with an encapsulating material 32, which fills in the gaps present for assembly and due to the shape of the components of ignition coil 10, and, in particular, fixedly positions core 12 and winding set 21 with respect to each other.

At this juncture, it should be mentioned that the design of ignition coil 10 described up to this point may be adapted or modified in various ways. It is only important for a core 12 to be concentrically enveloped by a coil set 21, and for the spaces between core 12 and coil set 21 to be filled in by an encapsulating material 32.

During operation of ignition coil 10, it is subjected to high thermal and mechanical stresses due to being installed near the engine. Since secondary coil shell 16 and encapsulating material 32 are made of plastic, whereas core 14 is made of metal, stress cracks in encapsulating material 32 and in secondary coil shell 16 may be produced due to the markedly different thermal expansion coefficients of these two components. In the worst-case scenario, these stress cracks cause a voltage spark-over or short circuit with core 14, and therefore result in the failure of ignition coil 10. Thus, core 14 is specially designed to compensate for the different coefficients of thermal expansion.

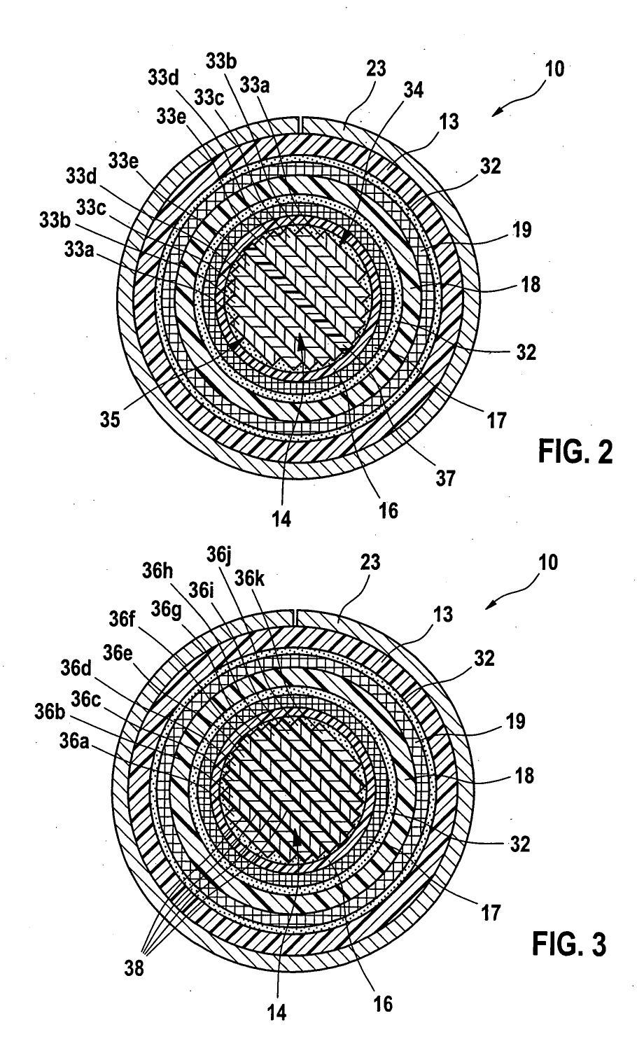

In the assembly shown in FIG. 2, core 14, as known per se, is made up of strip-like or lamellar magnetic steel sheets 33A through 33e having different widths. In this context, a set of magnetic steel sheets 33A through 33e forms a first half 34 of core 14, while a second set of magnetic steel sheets 33a through 33e forms a second half 35 of core 14. Individual magnetic steel sheets 33a through 33e of each half 34, 35 are joined one below the other to the end faces of halves 34, 35, using, for example, a keyed connection resulting from debossed sections, or by welding. Also conceivable are adhesive bonds or the envelopment of the two halves 34, 35 by a common covering, such as a shrink tube or a sleeve. The present invention provides for an elastic layer 37 to be situated between the two halves 34, 35. Layer 37 may be made of a thermoplastic, an elastomer, a thermoplastic elastomer, or lacquer (varnish) (enamel). In this context, layer 37 may extend over the entire length of magnetic steel sheets 33a through 33g, or only over a portion of the length. Layer 37 may also take the form of a varnish coating or plastic coating. It may also be present in the form of a foil or sheet. What is important is that the elasticity of layer 37 allow core 14 to compensate for stresses that result from the different thermal expansion coefficients of encapsulating material 32 and winding set 21.

As a revision to the specific embodiment shown in FIG. 2, the variant according to FIG. 3 provides that, instead of a single, centrally situated, elastic layer 37, several correspondingly thinner elastic layers 38 are positioned between individual magnetic steel sheets 36a through 36k.

The structure and composition of layers 37, 38 are equivalent to each other.

In the case of the specific embodiment according to FIG. 3, it is particularly useful for layers 38 to take the form of varnish layers. This allows the possibility of depositing layers 38 on one side or both sides of magnetic steel sheets 33a through 33h, directly at the sheet-metal manufacturer, if desired. From a standpoint of production engineering, magnetic steel sheets 36a through 36k are then formed at the coil manufacturer by punching them out of a larger sheet-metal plate.

The ignition coil 10 described up to this point may be adapted or modified in various ways. For example, it is particularly possible to position primary coil shell 18 inside of secondary coil shell 16, as well. Various modifications of the represented embodiments are also conceivable with regard to housing 13 and terminal parts 27, 28.

What is claimed is:

1. An ignition coil for,an internal combustion engine, comprising:
a magnetically active core including a plurality of core elements;
coil shells situated concentrically about the core and forming a primary coil and a secondary coil;
an encapsulating material filling-in spaces between the coil shells and the core; and
a damping element, interacting with the core, that compensates for different expansion coefficients of the core and coil shells, the damping element including at least one elastic layer situated between at least two of the core elements.

2. The ignition coil according to claim 1, wherein the elastic layer is connected to at least one of the core elements.

3. The ignition coil according to claim 2, wherein the connection is provided by one of a coating operation, a varnishing operation, an adhesive bonding, a thermal connecting method, and a keyed connection.

4. The ignition coil according to claim 1, wherein the layer is a movable layer.

5. The ignition coil according to claim 4, wherein the layer includes one of a sheet and a foil.

6. The ignition coil according to claim 1, wherein the core is surrounded at its circumference by an additional element, in the form of one of a sleeve and a shrink tube.

7. The ignition coil according to claim 1, wherein the layer is composed of one of a thermoplastic, an elastomer, a thermoplastic elastomer, and a varnish.

8. The ignition coil according to claim 1, wherein the core elements are lamellar.
